(19) United States
(12) Patent Application Publication
(10) Pub. No.: US 2015/0302293 A1
(43) Pub. Date: Oct. 22, 2015

(54) COUNTING MECHANISM FOR HYDRAULIC TIGHTENING DEVICE

(71) Applicant: Kevin Sheng-Yong Li, Irvine, CA (US)

(72) Inventor: Kevin Sheng-Yong Li, Irvine, CA (US)

(21) Appl. No.: 14/255,864

(22) Filed: Apr. 17, 2014

(51) Int. Cl. G06M 1/12; B25B 23/00; B23P 19/06

(52) U.S. Cl. CPC G06M 1/126; B23P 19/06; B25B 23/00

(57) ABSTRACT

A counting mechanism of a hydraulic tightening device that includes an oil input/output mechanism and a counting mechanism, wherein the counting mechanism includes a counter, a piston sealing, a driving piston, a spring, a spring cover, a counting unit, a piston restricting unit, a main body seal, a lower cover, a bolt and a restricting unit. The oil input/output mechanism is connected to the hydraulic tightening device through the counting mechanism, and once the hydraulic oil passes through the oil input/output mechanism, the counting mechanism automatically records as the hydraulic tightening device performs one more time.

### FIELD OF THE INVENTION

This invention relates to a counting mechanism, and more particularly to a counting mechanism for a hydraulic tightening device.

### BACKGROUND OF THE INVENTION

Currently, in the industrial equipment, bolts and nuts are often used for the connection between the key parts of large equipment. For example, thousands of large bolts and nuts are used in most thermal power equipment, water power equipment, nuclear power equipment, wind power equipment, metallurgical equipment, mining equipment, ship manufacturing equipment and petrochemical equipment. These bolts and nuts all need to be tightened and loosened by hydraulic tools or equipment to make sure the connection force between each bolt and nut is equal and the components of the equipment can be effectively, reliably and safely connected. Current hydraulic tightening devices or tools are disadvantageous because it is difficult to track how many times the hydraulic tightening device has been used. So, it is difficult to replace certain components in the hydraulic tightening device before those components are broken. In many occasions, people realize some components of the hydraulic tightening device need to be replaced because they are suddenly broken when used, which usually lead to damages to the hydraulic tightening device and more seriously cause people to injure or die.

After conventional hydraulic tightening devices are used for a certain period of time, mechanical fatigue may cause some mechanical components to break suddenly. Since it is difficult to track how many times the hydraulic tightening device has been used, it is also difficult to predict when is the best time to replace certain components of the hydraulic tightening device. As stated above, people start to realize some components of the hydraulic tightening device need to be replaced because they are suddenly broken when used, which usually lead to damages to the hydraulic tightening device and more seriously cause people to injure or die. Therefore, there is a need for a counting mechanism for the hydraulic tightening device.

### SUMMARY OF THE INVENTION

The present invention provides a counting mechanism of a hydraulic tightening device that includes an oil input/output mechanism and a counting mechanism, wherein the counting mechanism includes a counter, a piston sealing, a driving piston, a spring, a spring cover, a counting unit, a piston restricting unit, a main body seal, a lower cover, a bolt and a restricting unit, wherein the piston sealing is disposed in a sealing trough of the driving piston and the driving piston is plugged into the counter and the spring covered by the spring cover is used to connect with the driving piston, and the spring cover is connected with the counting mechanism through the bolt, wherein the piston restricting unit is plugged into the a piston restricting trough to prevent the driving piston from rotating, wherein the lower cover is used to plug into the counting mechanism to secure the counter and the counting mechanism is secured on the hydraulic tightening device through the bolt, and the main body seal is used to seal a hydraulic oil path to prevent leaking, wherein the oil input/output mechanism is connected to the hydraulic tightening device through the counting mechanism, and once the hydraulic oil passes through the oil input/output mechanism, the counting mechanism automatically records as the hydraulic tightening device performs one more time.

In one embodiment, when the hydraulic oil passes the counter to the hydraulic tightening device, pressure of the hydraulic oil drives the driving piston to outwardly move. In another embodiment, the outward movement of the driving piston is stopped when the spring is pressed to reach its minimum size. And when the pressure of the hydraulic oil decreases, the driving piston gradually restores to its original position, and the counter records once when the driving piston moves outward and restores due to the resilient force of the spring.

### BRIEF DESCRIPTION OF THE DRAWINGS

FIG. 1 illustrate a sectional view of the counting mechanism mounting that can be attached to the hydraulic tightening device in the present invention.

FIG. 2 illustrates a sectional view of the counter in the present invention.

FIG. 3 illustrates a perspective view of the counter in the present invention.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

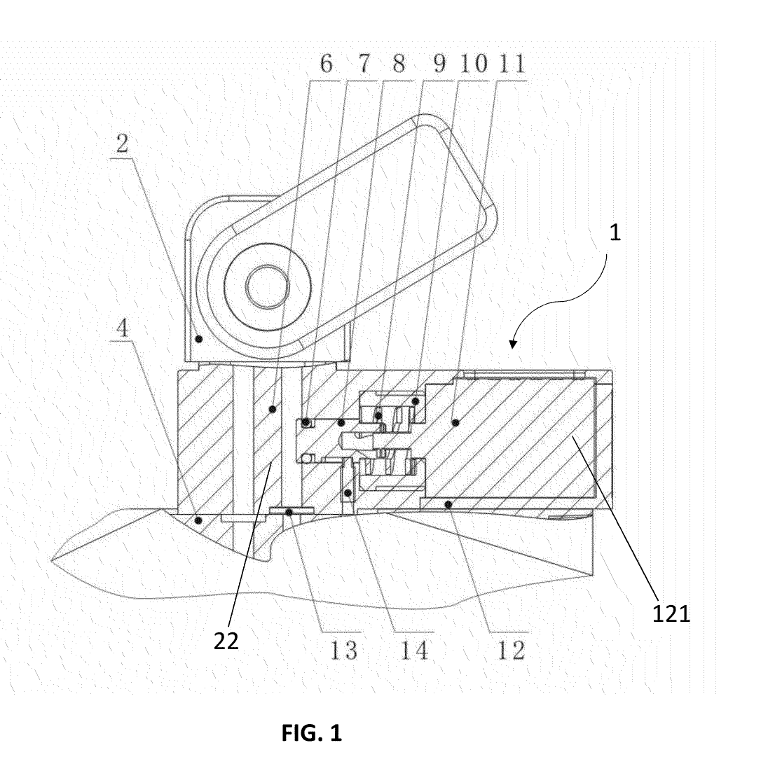

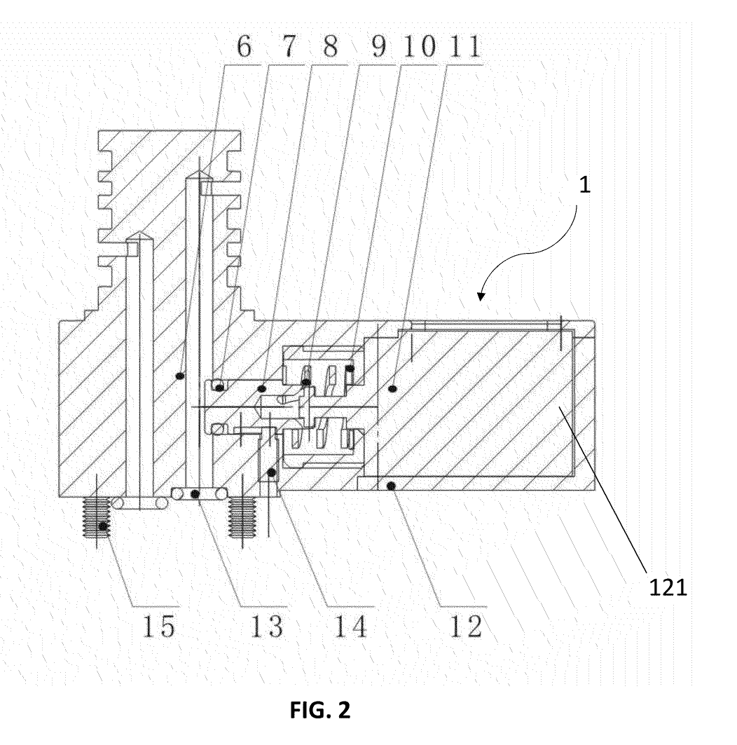

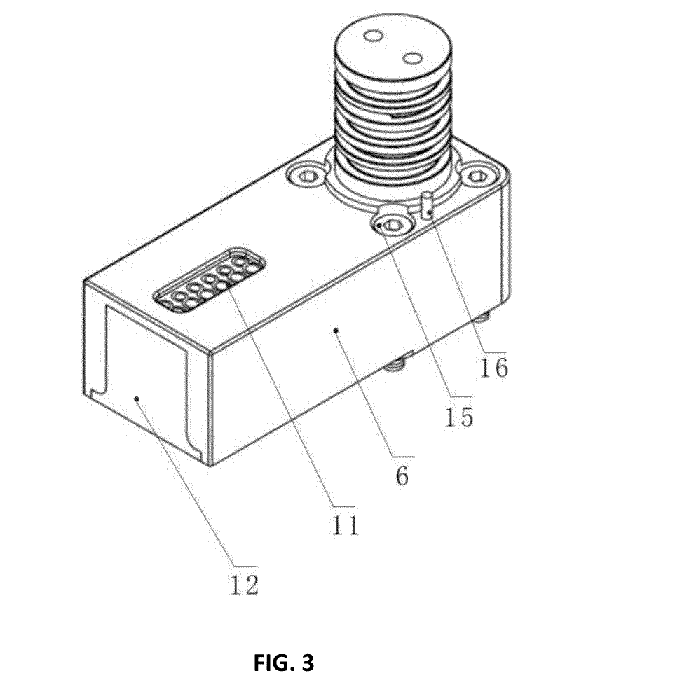

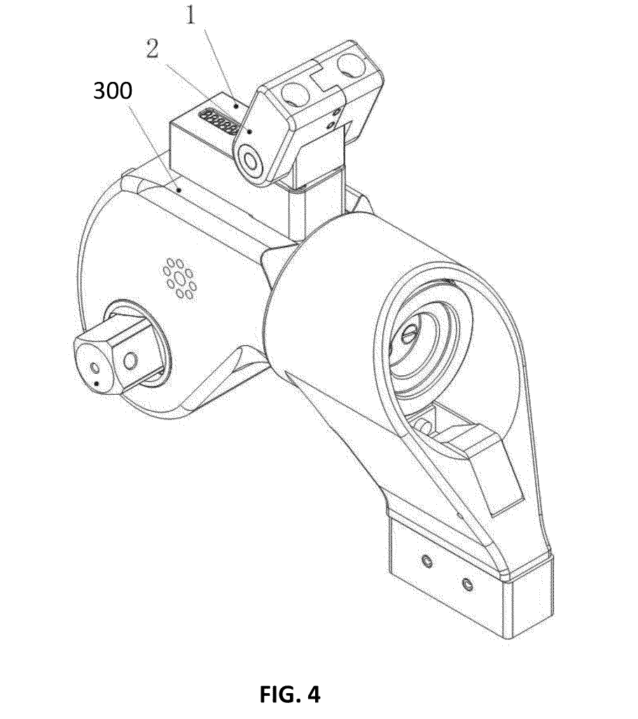

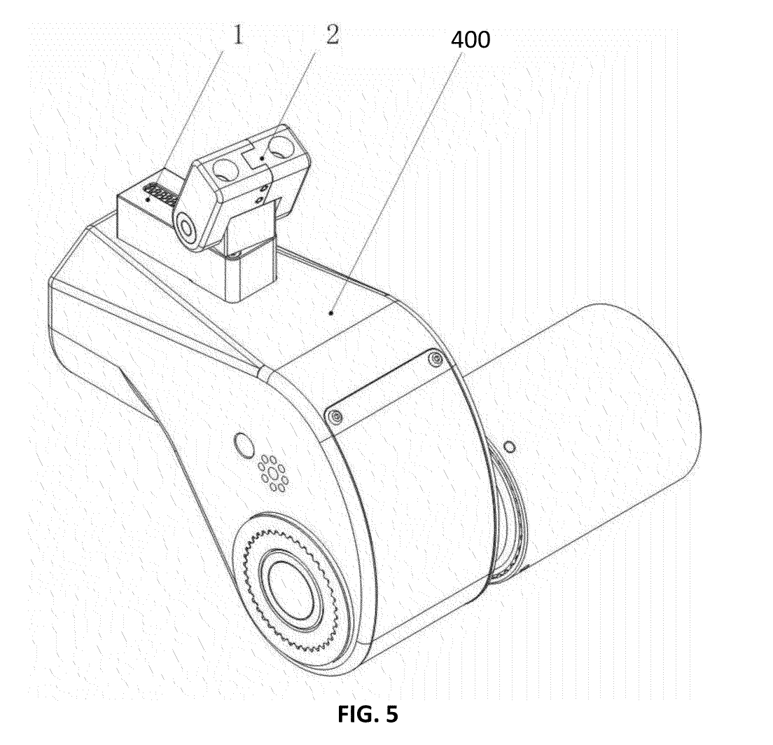

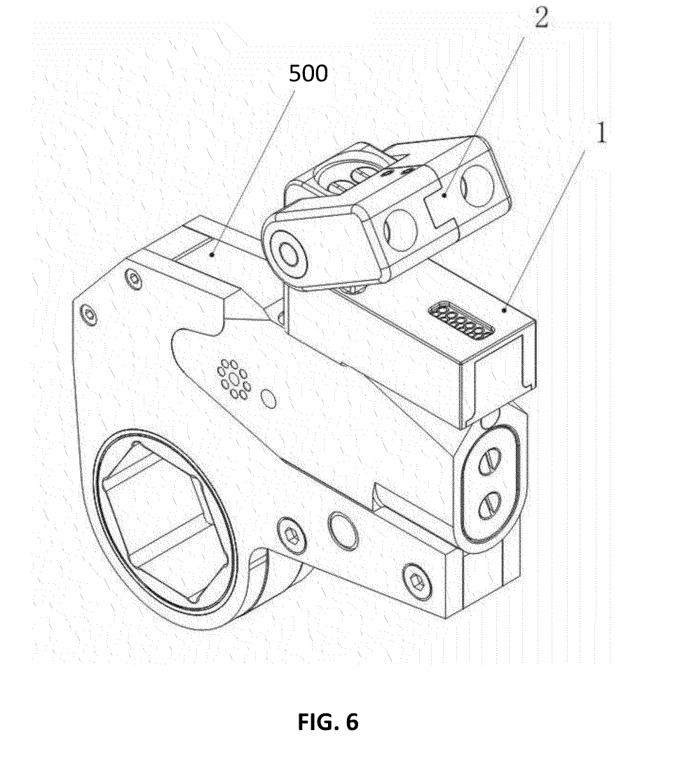

Referring to FIGS. 1 to 3, a counting mechanism for a hydraulic tightening device may include a counter 1, an oil input/output 2. The counter 1 may include a counter main body 6, a piston sealing 7, a driving piston 8, a spring 9, a spring cover 10, a counting unit 11, a piston restricting unit 12, a main body seal 13, a lower cover 14, a bolt 15 and a restricting unit 16. In one embodiment, the counter 1 is secured on the hydraulic tightening device through the bolt 15 and when hydraulic oil flows from the oil input/output 2 to the hydraulic tightening devices, the hydraulic oil has to pass through the counter main body 6, the driving piston 7 would be triggered to drive the counting unit 11 to record the increment of an existing number, indicating the hydraulic tightening devices has performed one time. In other words, the counting unit 11 can record the actual usage of the hydraulic tightening device when the hydraulic oil flows through the counter main body 6 and then to the hydraulic tightening devices. It is noted that the counting mechanism can be modified for different types of hydraulic tightening devices.

More specifically, wherein the piston sealing 7 is disposed in a sealing trough 71 of the driving piston 8 and the driving piston 8 is plugged into the counter 1 and the spring 9 covered by the spring cover 10 is used to connect with the driving piston 8, and the spring cover 10 is connected with the counter 1 through the bolt 15. It is noted that the piston restricting unit 12 is plugged into the a piston restricting trough 121 to prevent the driving piston 8 from rotating, wherein the lower cover 14 is used to secure the counter 1 and the counting mechanism is secured on the hydraulic tightening device through the bolt 15, and the main body seal 13 is used to seal a hydraulic oil path 22 to prevent leaking, wherein the oil input/output 2 is connected to the hydraulic tightening device through the counter 1, and once the hydraulic oil passes through the oil input/output 2, the counting mechanism automatically records as the hydraulic tightening device performs one more time.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A counting mechanism of a hydraulic tightening device comprising an oil input/output mechanism and a counting mechanism, wherein the counting mechanism includes a counter, a piston sealing, a driving piston, a spring, a spring cover, a counting unit, a piston restricting unit, a main body seal, a lower cover, a bolt and a restricting unit, wherein the piston sealing is disposed in a sealing trough of the driving piston and the driving piston is plugged into the counter and the spring covered by the spring cover is used to connect with the driving piston, and the spring cover is connected with the counting mechanism through the bolt, wherein the piston restricting unit is plugged into the a piston restricting trough to prevent the driving piston from rotating, wherein the lower cover is used to plug into the counting mechanism to secure the counter and the counting mechanism is secured on the hydraulic tightening device through the bolt, and the main body seal is used to seal a hydraulic oil path to prevent leaking, wherein the oil input/output mechanism is connected to the hydraulic tightening device through the counting mechanism, and once the hydraulic oil passes through the oil input/output mechanism, the counting mechanism automatically records as the hydraulic tightening device performs one more time.

2. The counting mechanism of a hydraulic tightening device of claim 1, wherein when the hydraulic oil passes the counter to the hydraulic tightening device, pressure of the hydraulic oil drives the driving piston to outwardly move.

3. The counting mechanism of a hydraulic tightening device of claim 2, wherein the outward movement of the driving piston is stopped when the spring is pressed to reach its minimum size.

4. The counting mechanism of a hydraulic tightening device of claim 3, wherein when the pressure of the hydraulic oil decreases, the driving piston gradually restores to its original position.

5. The counting mechanism of a hydraulic tightening device of claim 4, wherein the counter records once when the driving piston moves outward and restores due to the resilient force of the spring.
